(19) United States
(12) Patent Application Publication
(10) Pub. No.: US 2005/0223202 A1
(43) Pub. Date: Oct. 6, 2005

(54) Branch prediction in a pipelined processor

(75) Inventors: Ramesh V. Peri, Austin, TX (US); Ravi Kolagotla, Austin, TX (US); Juan Revilla, Austin, TX (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/813,268

(22) Filed: Mar. 31, 2004

(51) Int. Cl. G06F 9/00

(52) U.S. Cl. 712/237

(57) ABSTRACT

A new branch notification processor instruction may be added to a pipelined processor with static branch prediction. The instruction may be used to instruct the processor to fetch the instruction at the branch's target.

### BACKGROUND OF THE INVENTION

Some embodiments of the present invention are generally related to processors, and more particularly to pipelined processors that perform static branch prediction.

Branch instructions in software are usually a significant cause of stalls in processors, especially in pipelined processors. For example, in a six stage pipeline, with execution occurring in the 4^{th} stage, a branch instruction that is taken will cause up to 5 instructions to be killed in the pipeline. Such pipelined processors can include, for example, single-instruction-word (SIW) processors and very-long-instruction-word (VLIW) processors.

Conventional solutions to decreasing the impact of conditional branch mis-prediction suffer from various problems. Some solutions have a higher penalty for taken branches than for the not taken branches even when the branch prediction is correct. Other solutions are costly due to complexity of implementation and power consumption. Still others are very dependent on the availability of other instructions to be executed during a stall.

### BRIEF DESCRIPTION OF THE DRAWINGS

The invention shall be described with reference to the accompanying figures, wherein:

FIG. 1 depicts an example code fragment of processor instructions according to an embodiment of the present invention;

FIGS. 2A-D illustrate a progression of the code fragment of FIG. 1 through an exemplary six-stage processor pipeline, according to an alternative embodiment of the present invention;

FIGS. 3-4 illustrate diagrams of system environments capable of being adapted to perform the operations of static branch prediction, according to embodiments of the present invention; and

FIG. 5 illustrates a diagram of a computing environment capable of being adapted to perform the operations of static branch prediction, according to an embodiment of the present invention.

The invention is now described with reference to the accompanying drawings. In the drawings, like reference numbers generally indicate identical, functionally similar, and/or structurally similar elements. The drawing in which an element first appears is generally indicated by the left-most digit(s) in the corresponding reference number.

### DETAILED DESCRIPTION OF VARIOUS EMBODIMENTS

While embodiments of the present invention are described in terms of the examples below, this is for convenience only and is not intended to limit its application. In fact, after reading the following description, it will be apparent to one of ordinary skill in the art how to implement the following invention in alternative embodiments.

In this detailed description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In this detailed description and claims, the term “coupled,” along with its derivatives, such as, “connected” and “electrically connected”, may be used. It should be understood that “coupled” may mean that two or more elements are in direct physical or electrical contact with each other or that the two or more elements are not in direct contact but still cooperate or interact with each other.

According to some embodiments of the invention, an algorithm may be considered to be a self-consistent sequence of acts or operations leading to a desired result. These may include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

According to some embodiments of the invention, terms such as “processing,” “computing,” “calculating,” “determining,” or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, in some embodiments, the term “processor” may refer to any device or portion of a device that processes electronic data from registers and/or memory to transform that electronic data into other electronic data that may be stored in registers and/or memory. A “computing platform” may comprise one or more processors. In a similar manner, the term “branch” may refer to any instruction that causes a change in the sequential execution of instructions in a program. A “branch” may comprise, for example, a conditional or unconditional branch, a direct or indirect jump, or a subroutine jump or return.

Embodiments of the present invention may include apparatuses for performing the operations herein. An apparatus may be specially constructed for the desired purposes, or it may comprise a general purpose device selectively activated or reconfigured by a program stored in the device.

Embodiments of the present invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Embodiments of the present invention may provide a reduction in the penalty incurred when a branch is taken in a pipelined processor that uses static branch prediction. This reduction of taken branch penalty mechanism may be important to architectures that have either a large number of architected registers, such as in Intel Architecture-64 bit (IA-64), an instruction set architecture (ISA), or in large instruction windows for extracting instruction level parallelism (ILP) in an out-of-order execution core, in other ISAs, such as but not limited to IA-32, POWER PC®, and AMD 64®. POWER PC® is a registered trademark of International Business Machines Corp. of Armonk, N.Y. AMD 64® is a registered trademark of Advanced Micro Devices, Inc. of Sunnyvale, Calif. Additional trademark rights may apply. The present invention is not limited to these architectures, as one of ordinary skill in the art(s) would recognize, based at least on the teachings provided herein.

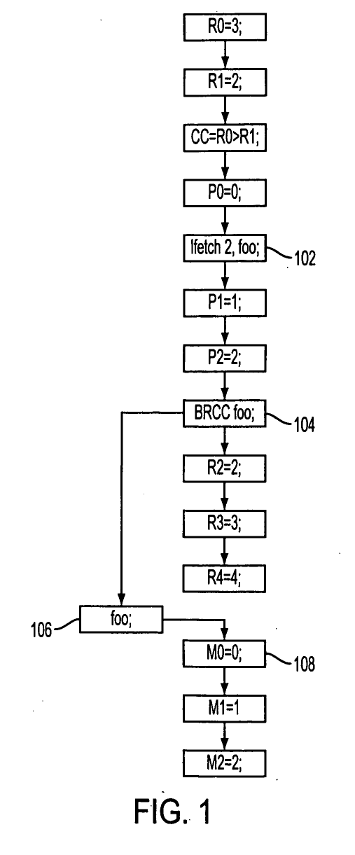

In an exemplary embodiment, the present invention may add a new branch notification instruction to a pipelined processor. The branch notification instruction may specify a distance to the next branch instruction and the target of the branch instruction. The branch notification instruction may be 16 or 32 bits, or another size in accordance with the needed offset. FIG. 1 shows an exemplary sample of a sequence of processor instructions including the branch notification instruction 102. The instructions may be loaded into the processor's pipeline in order from top to bottom. In this example, the branch notification instruction 102 may specify a distance, e.g. of two instructions, between itself and the branch instruction 106. It may also specify a branch target 108, e.g. “foo”. The branch notification instruction 102 may be inserted, for example, by a compiler, ahead of the actual branch instruction 106 so that the processor may fetch and execute the target instructions 108 speculatively before the target 106 of the branch instruction 104 is known in the decode stage. In one exemplary embodiment, the branch notification instruction 102 may encode the instruction at which the branch is present, facilitating the micro-architecture in deciding how to handle the branch notification instruction.

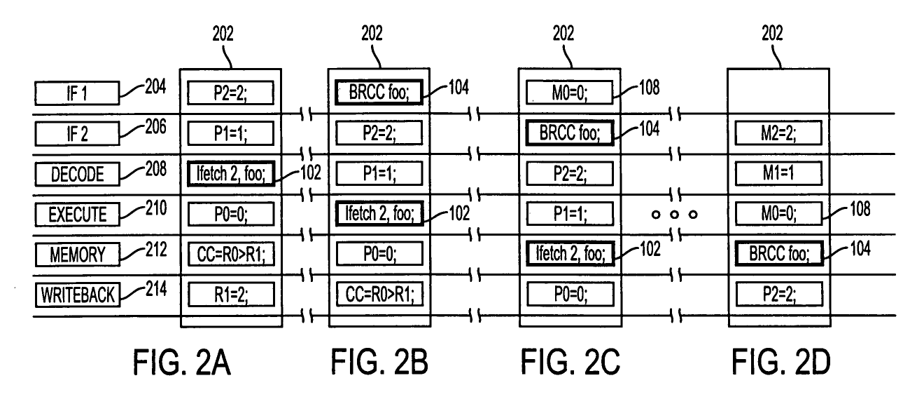

FIGS. 2A-2D show an example progression of the instructions from FIG. 1 through a 6-stage pipeline 202. The six stages of the pipeline shown are instruction fetch 1 (IF1) 204, instruction fetch 2 (IF2) 206, decode 208, execute 210, memory 212, and write-back 214. In FIG. 2A, the branch notification instruction 108 may be decoded. In FIG. 2B, the branch notification instruction 108 may be executed while the branch instruction 104 is fetched. In FIG. 2C, because the branch notification instruction 108 was just executed, the next instruction to be fetched into IF1 204 may be the instruction 108 at the branch target. In FIG. 2D, processing has advanced three stages in the pipeline, and the branch instruction 104 has just been executed. The next instruction ready to be executed is the instruction 108 at the branch target.

In an exemplary embodiment, not all types of branches need to be predicted. A compiler may decide to predict branches by inserting the branch notification instruction into the machine code based on a specified setting. For example, if one branch type is used more than a certain number of times, the branch may always be predicted as taken. If another branch type is used only occasionally, no branch prediction may be necessary, and no branch notification instruction may be used for that branch type.

According to the operating environments discussed below, embodiments of the present invention, according to the embodiments described above, may be implemented in an apparatus designed to perform these operations.

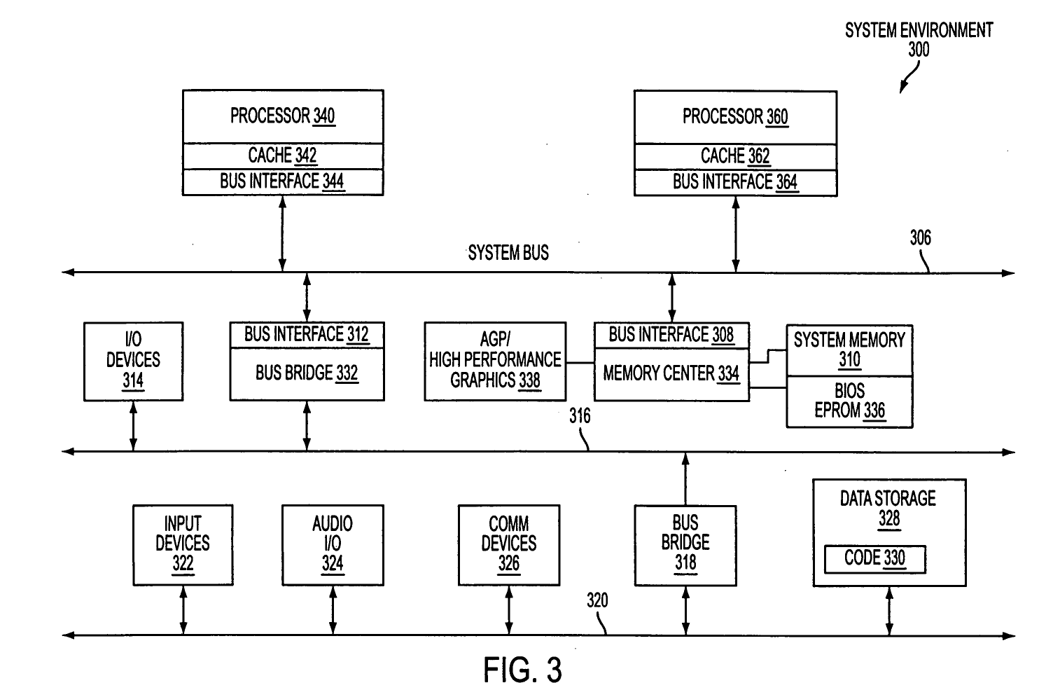

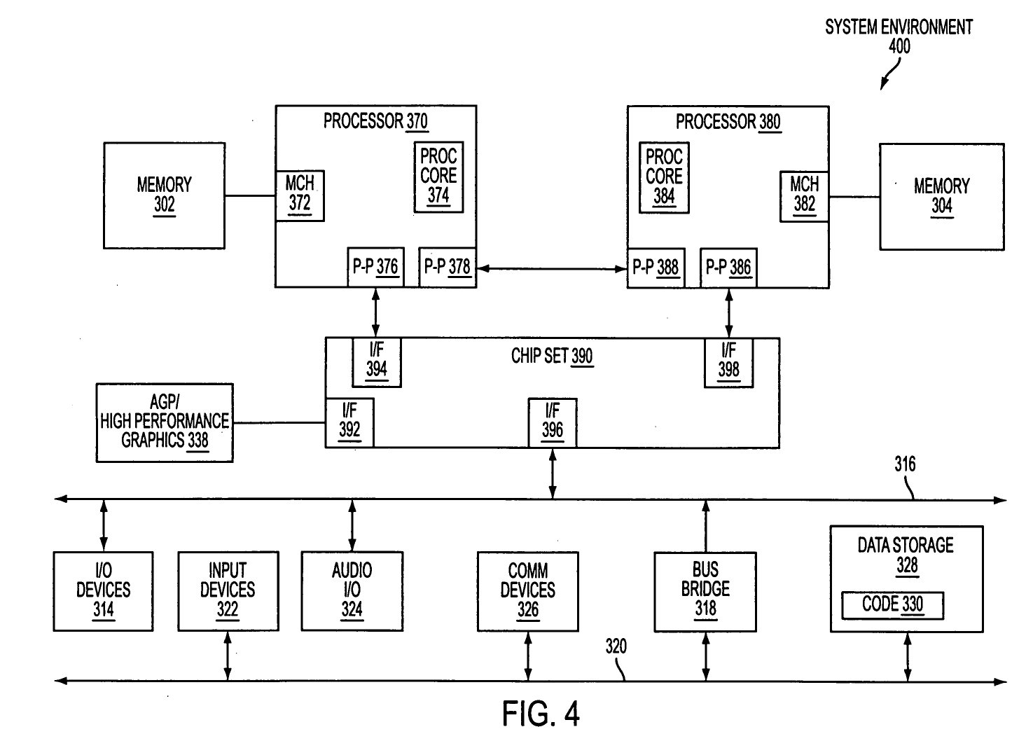

Specifically, and only by way of example, embodiments of the present invention may be implemented using one or more microprocessor architectures or a combination thereof and may be implemented with one or more memory hierarchies. In fact, in one embodiment, the invention may be directed toward one or more processor environments capable of carrying out the functionality described herein. Examples of system environments 300 and 400 are shown in FIGS. 3 and 4 and may include one or more central processing units, memory units, and buses. The system environments 300 and 400 may include a core logic system chip set that connects a microprocessor to a computing system. Various microprocessor architecture embodiments may be described in terms of these exemplary micro-processing and system environments. After reading this description, it will become apparent to a person of ordinary skill in the art how to implement the invention using other micro-processing and/or system environments, based at least on the teachings provided herein.

Referring now to FIGS. 3 and 4, schematic diagrams of systems including a processor including the branch notification instruction are shown, according to two embodiments of the present invention. The system environment 300 generally shows a system where processors, memory, and input/output devices may be interconnected by a system bus, whereas the system environment 400 generally shows a system where processors, memory, and input/output devices may be interconnected by a number of point-to-point interfaces.

The system environment 300 may include several processors, of which only two, processors 340, 360 are shown for clarity. Processors 340, 360 may be SIW or VLIW processors and may include level one (LI) caches 342, 362. The system environment 300 may have several functions connected via bus interfaces 344, 364, 312, 308 with a system bus 306. In one embodiment, system bus 306 may be the front side bus (FSB) utilized with Pentium® class microprocessors. In other embodiments, other busses may be used. In some embodiments memory controller 334 and bus bridge 332 may collectively be referred to as a chip set. In some embodiments, functions of a chipset may be divided among physical chips differently from the manner shown in the system environment 300.

Memory controller 334 may permit processors 340, 360 to read and write from system memory 310 and/or from a basic input/output system (BIOS) erasable programmable read-only memory (EPROM) 336. In some embodiments BIOS EPROM 336 may utilize flash memory. Memory controller 334 may include a bus interface 308 to permit memory read and write data to be carried to and from bus agents on system bus 306. Memory controller 334 may also connect with a high-performance graphics circuit 338 across a high-performance graphics interface 392. In certain embodiments the high-performance graphics interface 392 may be an advanced graphics port (AGP) interface. Memory controller 334 may direct read data from system memory 310 to the high-performance graphics circuit 338 across high-performance graphics interface 392.

The system environment 400 may also include several processors, of which only two, processors 370, 380 are shown for clarity. Processors 370, 380 may each include a local memory channel hub (MCH) 372, 382 to connect with memory 302, 304. Processors 370, 380 may each include a processor core 374, 384. Processors 370, 380 may exchange data using point-to-point interface circuits 378, 388. Processors 370, 380 may each exchange data with a chipset 390 using point to point interface circuits 376, 394, 386, 398. Chipset 390 may also exchange data with a high-performance graphics circuit 338 via a high-performance graphics interface 392.

In the system environment 300, bus bridge 332 may permit data exchanges between system bus 306 and bus 316, which may in some embodiments be a industry standard architecture (ISA) bus or a peripheral component interconnect (PCI) bus. In the system environment 400, chipset 390 may exchange data with a bus 316 via a bus interface 396. In either system, there may be various input/output I/O devices 314 on the bus 316, including in some embodiments low performance graphics controllers, video controllers, and networking controllers. Another bus bridge 318 may in some embodiments be used to permit data exchanges between bus 316 and bus 320. Bus 320 may in some embodiments be a small computer system interface (SCSI) bus, integrated drive electronics (IDE) bus, or universal serial bus (USB) bus. Additional I/O devices may be connected with bus 320. These may include input devices 322, which may include, but are not limited to, keyboards, pointing devices, and mice, audio I/O 324, communications devices 326, including modems and network interfaces, and data storage devices 328. Software code 330 may be stored on data storage device 328. In some embodiments, data storage device 328 may be, for example, but is not limited to, a fixed magnetic disk, a floppy disk drive, an optical disk drive, a magneto-optical disk drive, a magnetic tape, or non-volatile memory including flash memory.

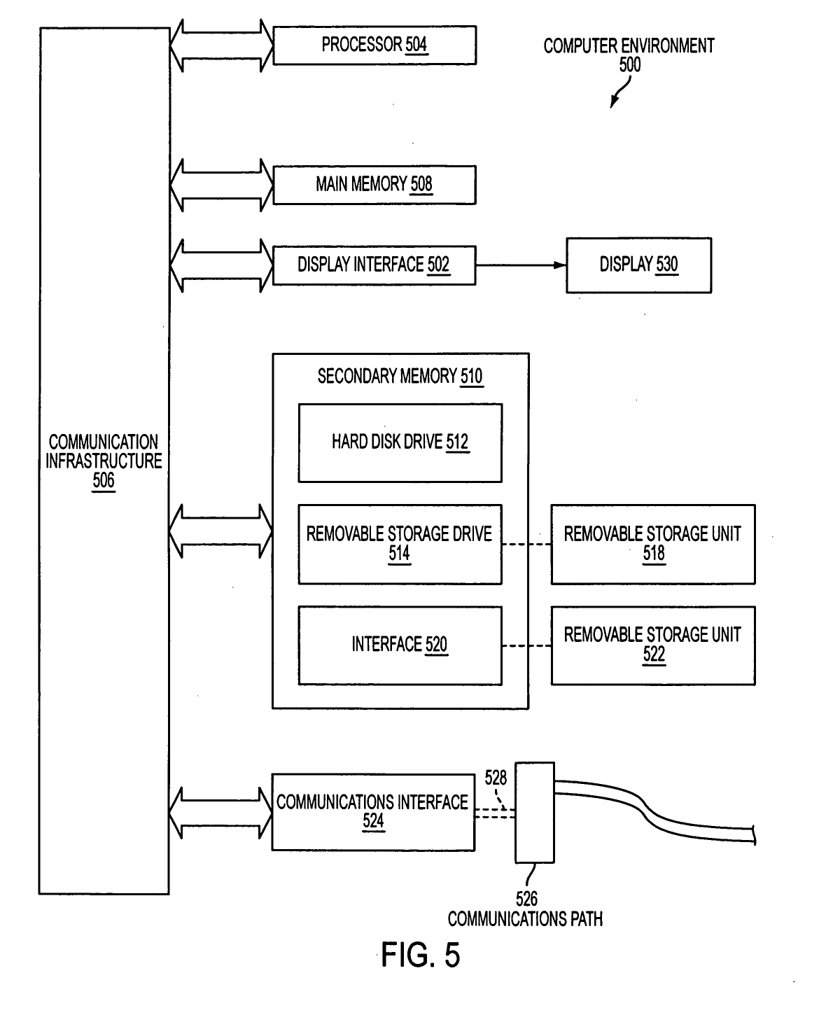

Embodiments of the present invention may be implemented using hardware, software or a combination thereof and may be implemented in one or more computer systems or other processing systems. In fact, in one embodiment, the invention may comprise one or more computer systems capable of carrying out the functionality described herein. An example of a computer system 500 is shown in FIG. 5. The computer system 500 may include one or more processors, such as processor 504. The processor 504 may be connected to a communication infrastructure 506 (e.g., a communications bus, cross over bar, or network). Various software embodiments are described in terms of this exemplary computer system. After reading this description, it will become apparent to a person skilled in the relevant art(s) how to implement the invention using other computer systems and/or computer architectures.

Computer system 500 may include a display interface 502 that may forward graphics, text, and other data from the communication infrastructure 506 (or from a frame buffer not shown) for display on the display unit 530.

Computer system 500 may also include a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc, but which is not limited thereto. The removable storage drive 514 may read from and/or write to a removable storage unit 518 in a well known manner. Removable storage unit 518, may represent a floppy disk, magnetic tape, optical disk, etc., which may be read by and written to by removable storage drive 514. As will be appreciated, the removable storage unit 518 may include a computer usable storage medium having stored therein computer software and/or data.

In alternative embodiments, secondary memory 510 may include other similar means for allowing computer programs or other instructions to be loaded into computer system 500. Such means may include, for example, a removable storage unit 522 and an interface 520. Examples of such may include, but are not limited to, a program cartridge and cartridge interface (such as that found in video game devices), a removable memory chip (such as an EPROM, or PROM) and associated socket, and/or other removable storage units 522 and interfaces 520 that may allow software and data to be transferred from the removable storage unit 522 to computer system 500.

Computer system 500 may also include a communications interface 524. Communications interface 524 may allow software and data to be transferred between computer system 500 and external devices. Examples of communications interface 524 may include, but are not limited to, a modem, a network interface (such as an ethernet card), a communications port, a PCMCIA slot and card, etc. Software and data transferred via communications interface 524 are in the form of signals 528 which may be, for example, electronic, electromagnetic, optical or other signals capable of being received by communications interface 524. These signals 528 may be provided to communications interface 524 via a communications path (i.e., channel) 526. This channel 526 may carry signals 528 and may be implemented using wire or cable, fiber optics, a phone line, a cellular phone link, an RF link and/or other communications channels.

The terms “computer program medium” and “computer usable medium” may be used to generally refer to media such as, but not limited to, removable storage drive 514, a hard disk installed in hard disk drive 512, and signals 528. These computer program media are means for providing software to computer system 500.

Computer programs (also called computer control logic) may be stored in main memory 508 and/or secondary memory 510. Computer programs may also be received via communications interface 524. Such computer programs, when executed, enable the computer system 500 to perform the features of the present invention as discussed herein. In particular, the computer programs, when executed, may enable the processor 504 to perform the present invention in accordance with the above-described embodiments. Accordingly, such computer programs represent controllers of the computer system 500.

In an embodiment where the invention may be implemented using software, the software may be stored in a computer program product and loaded into computer system 500 using, for example, removable storage drive 514, hard drive 512 or communications interface 524. The control logic (software), when executed by the processor 504, may cause the processor 504 to perform the functions of the invention as described herein.

In another embodiment, the invention may be implemented primarily in hardware using, for example, hardware components such as application specific integrated circuits (ASICs). Implementation of the hardware state machine so as to perform the functions described herein will be apparent to persons skilled in the relevant art(s). As discussed above, embodiments of the invention may be implemented using any combination of hardware, firmware and software.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above described exemplary embodiments, but should be defined only in accordance with the following claims and their equivalents.

1. A processor, comprising:
an instruction pipeline having N stages;
an instruction set, comprising a branch instruction and a branch notification instruction operative to receive at least one argument M; and
a loading module to place instructions in said instruction pipeline,
wherein said branch notification instruction is to indicate to said loading module via said at least one argument M that a branch instruction will occur within M instructions in said instruction pipeline, and wherein when said branch notification instruction is executed, said loading module is to load an instruction beginning at a branch point for said branch.

2. The processor of claim 1, wherein said branch notification instruction has at least two arguments comprising a number of instructions M, and a branch target.

3. The processor of claim 1, wherein said branch notification instruction is at least one of 16 bits or 32 bits.

4. A method of static branch prediction, comprising:
inserting a branch notification instruction into an instruction sequence before a branch instruction, wherein said branch notification instruction indicates a separation of M instructions from said branch instruction, and wherein said branch has a branch target;
executing said branch notification instruction; and
fetching an instruction starting at said branch target immediately after executing said branch notification instruction.

5. The method of claim 4, wherein said inserting a branch notification instruction further comprises: inserting a branch notification instruction indicating both a separation of M instructions from said branch instruction and a branch target.

6. The method of claim 4, wherein said inserting a branch notification instruction further comprises inserting one of a 16 bit and 32 bit branch notification instruction according to said separation M.

7. A machine-accessible medium containing software code that, when read by a computer, causes the computer to perform a method comprising:
inserting a branch notification processor instruction in an instruction sequence before a branch instruction, wherein said branch notification instruction indicates a separation of M instructions from said branch instruction, and wherein said branch instruction has a branch target;
executing said branch notification instruction; and
fetching an instruction starting at said branch target immediately after executing said branch notification instruction.

8. The machine-accessible medium of claim 7, wherein said inserting a branch notification instruction further comprises: inserting a branch notification instruction indicating both a separation of M instructions from said branch instruction and a branch target.

9. The machine-accessible medium of claim 7, wherein said inserting a branch notification instruction further comprises inserting one of a 16 bit and 32 bit branch notification instruction according to said separation M.

10. A system, comprising:
a random-access memory;
a processor coupled to said memory, said processor comprising:
an instruction pipeline having N stages;
an instruction set, comprising a branch instruction and a branch notification instruction operative to receive at least one argument M; and
a loading module to place said sequence of instructions in said instruction pipeline;
wherein said branch notification instruction is to indicate to said loading module via said at least one argument M that a branch instruction will occur within M instructions in said instruction sequence, and wherein when said branch notification instruction is executed, said loading module is to load an instruction beginning at a branch point for said branch.

11. The system of claim 10, wherein said branch notification instruction has at least two arguments comprising:
a number, which indicates the location of forthcoming branch instruction in said sequence of instructions; and
a branch target location.

12. The system of claim 10, wherein said branch notification instruction is at least one of 16 bits or 32 bits, depending on the offset needed to encode the branch target.
